(19) United States
(12) Patent Application Publication
(10) Pub. No.: US 2005/0168485 A1
(43) Pub. Date: Aug. 4, 2005

(54) System for combining a sequence of images with computer-generated 3D graphics

(76) Inventor: Thomas Graeme Nattress, Ontario (CA)

Correspondence Address: JENKENS & GILCHRIST, P.C., 225 WEST WASHINGTON, SUITE 2600, CHICAGO, IL, 60606, US

(21) Appl. No.: 10/767,515

(22) Filed: Jan. 29, 2004

(51) Int. Cl. G09G 5/00

(52) U.S. Cl. 345/632

(57) ABSTRACT

A method for producing composite images of real images and computer-generated 3D images uses camera-and-lens sensor data. The real images can be live, or pre-recorded, and may originate on film or video. The computer-generated 3D images are generated live, simultaneously with the film or video and can be animated or still based upon pre-prepared 3D data. A live image, which may be preview-quality is generated on the video or film production set, and the information gathered from the sensors is stored to allow a high-quality composite to be generated in post-production. Due to the use of sensor data, an accurate simulation of depth-of-field and focus can be generated.

### FIELD OF THE INVENTION

The invention relates to producing a series of generated images in response to data from a camera/lens system in such a way that the generated images match the visual representation resulting from the data parameters. The optical qualities of the generated images are similar to the optical qualities of the images resulting from the camera/lens system. Optical qualities that may be modified according to the present invention include qualities such as depth of field, focus, t-stop (exposure), field of view and perspective.

### BACKGROUND OF THE INVENTION

The present invention is designed to facilitate the use of “virtual sets” in motion pictures. Virtual sets are similar to the real, physical sets used in the motion picture and TV industries in that they create an environment for actors to perform in, but whereas physical sets are constructed using real materials, virtual sets are constructed inside a computer using 3D graphics techniques. The area of the studio around where the actors are performing is made to be a specific color, usually green or blue. The virtual set is not usually visible to the actors, but is visible to the video cameras recording the actors by way of compositing techniques that remove the green or blue background and replace it with the computer-generated 3D virtual set graphics. This background removal technique is called chroma-key. Compositing software and systems are specialist film and television industry tools designed for working with the layering and combining of video images and special effects including the chroma-key. Compositing can be done using a hardware or hardware/software combination and can either be used in real-time generating composite images as they are input into the system or off-line where stored images are processed.

It is desirable for a good-looking virtual set that there is an accurate dynamic link between the camera recording the actors and the computer generating the 3D graphics. It is preferred that the computer receives data indicating precisely where the camera is, which direction it is pointing, and what the status of the lens focus, zoom and aperture is for every frame of video recorded. This ensures that the perspective and view of the virtual set is substantially the same as that of the video of the actor that is being placed into the virtual set, and that when the camera moves, there is synchronization between the real camera move and the view of the virtual set.

### SUMMARY OF THE INVENTION

It is possible to use knowledge of the orientation and position of a camera to assist the production of virtual sets.

The present invention is generally directed to the use of lens sensor information to produce:
accurate synchronization between the real camera lens and the computer simulation of the lens,
accurate computer graphic representations of depth of field and focus,
and accurate geometrical correspondence by taking into account the movements of the individual lens elements inside the camera.

This invention allows for animations to be sequenced in real time as part of the virtual computer-generated graphics to synchronize special effects. The system is also optimized to facilitate the use of the sensor data in post production by converting the sensor data via a calibration mechanism to standard computer graphics formats that can be used in a wide variety of compositing and 3D animation computer software.

The above summary of the present invention is not intended to represent each embodiment, or every aspect, of the present invention. Additional features and benefits of the present invention will become apparent from the detailed description, figures, and claims set forth below.

### BRIEF DESCRIPTION OF THE DRAWINGS

FIG. 1 shows a camera and its components;

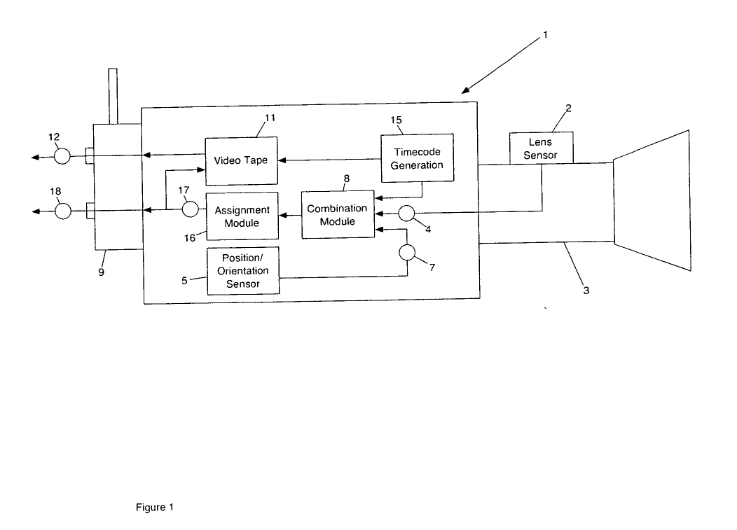

FIG. 2 shows how the elements of the system are inter-connected;

FIG. 3 shows details of a computer system;

FIG. 4 shows details of a true lens position computation and relation to the fixed reference point.

While the invention is susceptible to various modifications and alternative forms, specific embodiments are shown by way of example in the drawings and are described in detail herein. It should be understood, however, that the invention is not intended to be limited to the particular forms disclosed. Rather, the invention is to cover all modifications, equivalents and alternatives falling within the spirit and scope of the invention as defined by the appended claims.

### DETAILED DESCRIPTION OF THE INVENTION

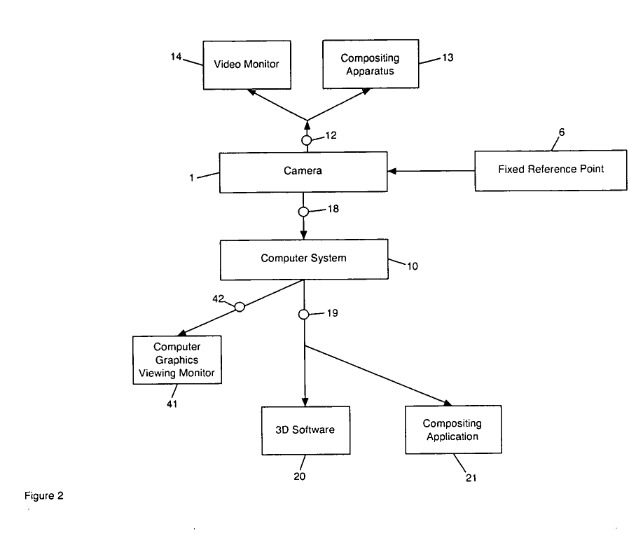

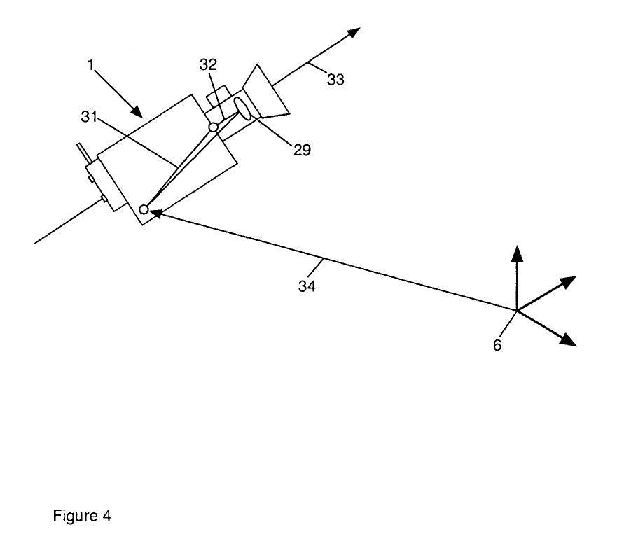

A camera 1 such as a film, video, or high-definition video camera can be fitted with sensors 2 as part of the lens 3. The lens sensors 2 can produce a digital signal 4 that represents the positions of the lens elements they are sensing. Additional position and orientation sensors 5 on the camera itself can reference their positions to a fixed reference point 6 (shown in FIG. 4) not attached to the camera. The camera sensors also produce a digital signal 7, which is later combined at a combination module 8 with the lens sensor signal to be transmitted from a transmission unit 9 to a computer system 10 as shown in FIG. 2. The camera itself records the image presented to it, for example, via videotape 11, and can also transmit from an output 12 (via cable or other means) the video image to a compositing 13 or monitoring 14 apparatus. The camera also generates a time code 15 which it uniquely assigns to each frame of video using an assignment module 16. Assigning the same timecode to the set of collected sensor data recorded at the same time produces meta-data 17 of the camera image.

This meta-data can then be transmitted from an output 18 to a computer system (by cable, wireless or other means) where processing can take place that will convert the meta-data into camera data 19. The camera data is used by 3D computer graphics software 20 or compositing application 21 (as shown in FIG. 2) to allow the systems to accurately simulate the real camera in terms of optical qualities such as position, orientation and focus, aperture and depth of field.

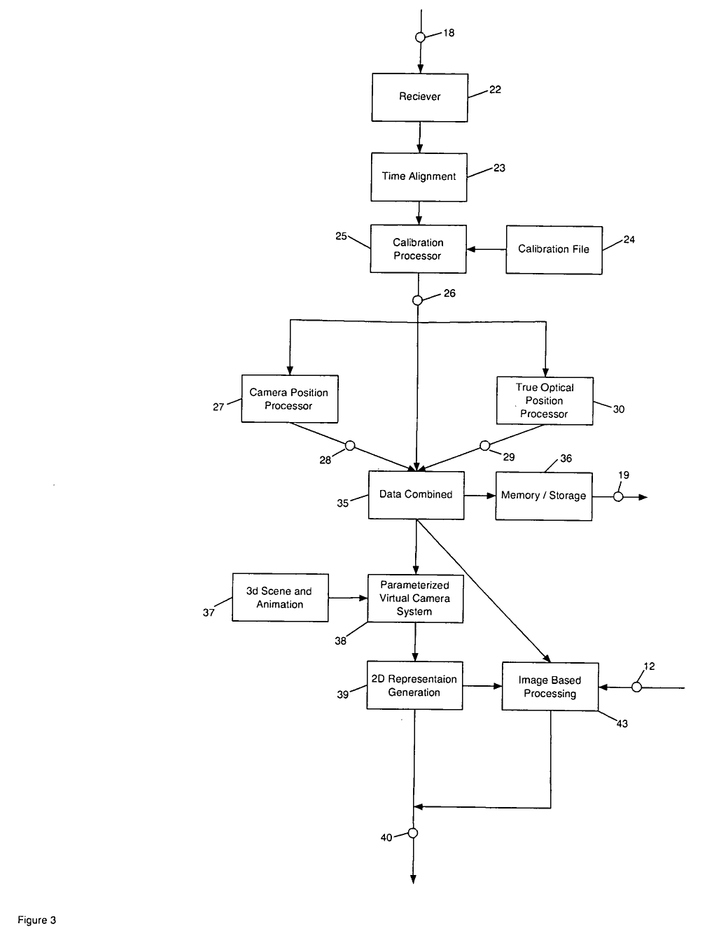

Turning now to FIG. 3, after the computer system has received the meta-data as shown at block 22, the first stage of the processing of meta-data into camera data is to time-align the various individual streams of meta-data as shown at block 23. In some embodiments employing a plurality of sensors the exact moment in time that one sensor generates its digital sample may not correspond to the exact moment in time that other sensors use, although it is preferred that all sensors are synchronized to the same timecode. The time-code is usually accurate to 1/24, 1/25 or 1/30 of a second, depending on video format, but with rapid changes in meta-data, for instance during a crash zoom, it is necessary to make sure that each individual meta-data stream's value represents the same instance within the 1/24, 1/25 or 1/30 of a second interval. By interpolating the individual meta-data streams to find their value at a time between timecode samples, minute time shifts can be added or subtracted to each stream to correct for time sampling differences. This information can be stored as part of a calibration file or calculated by making the camera perform a known task and measuring the time offsets.

Each lens that is equipped with sensors for use in this process may require a calibration file 24. This calibration file contains mappings of sensor data to camera data. It also contains calibrations for the moving lens elements. Each stream of meta-data is run through the calibration processor 25, using interpolation, to produce calibrated camera data 26. The meta-data for the position of the camera sensors is converted via standard trigonometrical techniques as shown at block 27 to produce orientational camera data 28. Orientational camera data consists of the position of the camera in 3 dimensional space (x, y and z coordinates) and the rotation of the camera in each of the x, y and z axis.

Because some embodiments of the present invention take into account the lens movements, the 3D point in the camera data that represents the true optical position of the camera 29 is calculated as shown at block 30 by taking the fixed lens length offset 31 (illustrated in FIG. 4) and adding it to the calculated moving lens offset 32 in the orientation of the camera 33, and adding that vector to the vector representing the base position of the camera 34 relative to the fixed reference point.

The true optical position of the camera is important because the calculations to produce the accurate camera data are only as accurate as the accuracy of the position data. When the focus or zoom of the camera is changed, the optical center of the camera changes because the various lens elements inside the camera move.

The calibrated camera data, orientational camera data, and true optical position of the camera data are combined together as shown at block 35 to be stored on computer disc or other storage 36 for later use in either a 3D computer graphics system or compositing system.

In real time, 3D computer graphics techniques can display a pre-prepared or generated animation or scene 37. The virtual camera 38 used in the 3D techniques uses the accurate information from the camera data to allow it to produce graphics 40, as shown in block 39, which correspond to the video images in terms of position, orientation and perspective, field of view, focus, and depth of field—the optical qualities.

The computer graphic images are displayed on a monitor 41, as shown in FIG. 2, and also transmitted 42 to a video monitor or compositing apparatus. The compositing apparatus can display a composite image of the video from the camera and the corresponding computer graphics generated by the 3D computer graphics techniques using the information from the camera data.

Image-based processing 43 of the computer graphics can be used to enhance the alignment between the computer graphics and the recorded video. Image-based processing works on the individual pixels that make up the visual display of the computer graphics, rather than on the 3D data that is used to render the 3D data into a visual form. The image based processing can be applied to either the preview quality computer graphics that are generated in real time, or the higher quality computer graphics that are produced as the final quality computer graphics in post production. Image based processing can also be applied to the video images recorded by the camera. An example of image based processing that can be used to enhance the alignment between computer graphics and recorded video is the simulation of lens distortion.

Lens distortion, where the video image recorded by the camera appears distorted due to the particular lenses being used by the camera, can also be applied to the computer graphics using image-based processing techniques. Computer graphics generally do not exhibit any lens distortion because a lens is not used in their production. The computer simulation of a virtual camera will generally not produce lens distortions. If the computer simulation of a virtual camera is capable of simulating lens distortions then the lens information from the camera data can be used as parameters in the simulation of the virtual camera, otherwise the image processing techniques can be used.

Lens distortion varies as the lens elements move inside the camera. By using the lens information from the camera data, the correct nature and amount of lens distortion can be calculated and made to vary with any adjustments to the lens elements in the camera. Similarly, an inverse lens distortion can also be calculated. An inverse distortion is an image based process such that applying it will remove the lens distortion present in the image. To ensure an accurate visual match between the video images and the computer graphics, either the lens distortion from the video images can be applied to the computer graphics, or the lens distortion can be removed from the video images.

In the first case, the video images have lens distortion caused by the lenses used in the camera, and an equivalent distortion in terms of nature and amount are calculated from the camera data and applied to the computer graphics via the image-based processing. In the second case, the computer graphics have no lens distortion due to the lack of lens distortion simulation in the 3D virtual camera that is used to produce them, and the video images have no lens distortion due to the application of the inverse distortion using image-based processing upon the video images.

3D computer graphics rendering techniques are constantly improving in both quality and speed. During the post production phase, in a high-quality 3D computer graphics rendering or compositing program, the recorded camera data can be used to render an accurate representation of focus and depth of field.

An example of the meta-data:

Each line of meta-data represents what is happening to the lens and camera at an instance of time, which is specified by the timecode.

Timecode refers to the time a frame of video or film is recorded at. The four numbers represent hours, minutes, seconds and frames. Film and video for theatrical presentation is generally shot at 24 frames per second, hence each frame lasts 1/24th of a second.

The Pan, Tilt, Focus, T-Stop and Zoom numbers are all raw encoder data. The raw encoder data is specific to the encoding system used to measure the movement of the camera and lens. The encoder data is in no specific system of units, and hence must be converted before being used. In this case, each timecode has an associated set of meta-data that describes the status of a calibrated tripod head in terms of pan and tilt and a calibrated lens in terms of focus, t-stop and zoom.

| Timecode | Pan | Tilt | Focus | T-Stop | Zoom |
|---|---|---|---|---|---|
| 01:26:39:03 | 502382 | −773 | 80298 | −3009 | 84307 |
| 01:26:39:04 | 502409 | −780 | 79893 | −3009 | 84245 |

We know from the timecode in which 1/24th of a second instance each line of the meta-data was recorded at. In this particular case, it has been measured that the pan and tilt meta-data are recorded near the end of the 1/24th second interval, precisely 9/10th of a frame or 0.375 of a second after the other meta-data.

Time synchronization is performed, in this particular case, by delaying the pan and tilt meta-data by the measured 9/10th fraction of one frame:

Pan at time 01:26:39:03 is 502382

Pan at time 01:26:39:04 is 502409
subtracting the Pan meta-data gives a difference of 27.

Fractional delay is 9/10th of one frame.

9/10th multiplied by 27 is 24.3.

Subtracting 24.3 from the Pan at the 01:26:39:04 timecode (502409) gives 502384.7.

Tilt at time 01:26:39:03 is −773

Tilt at time 01:26:39:04 is −780
subtracting the Tilt meta-data gives a difference of −7.

Fractional delay is 9/10th of one frame.

9/10th multiplied by −7 is −6.3.

Subtracting −6.3 from the Tilt at the 01:26:39:04 timecode (−780) gives −773.7.

The time-corrected meta-data for the 01:26:39:04 timecode now reads:

| Timecode | Pan | Tilt | Focus | T-Stop | Zoom |
|---|---|---|---|---|---|
| 01:26:39:04 | 502384.7 | −773.7 | 79893 | −3009 | 84245 |

The next stage is to use calibration tables to convert the meta-data to camera data.

In this particular system, a series of encoder values are mapped to Focus, T-Stop or Zoom values via a look-up table. The Pan and Tilt values are directly related to degrees of rotation.

Pan is calculated by taking the meta-data value, dividing by 8192 and then multiplying by 18. Therefore, the Pan meta-data value of 502384.7 represents an angle of 1103.9 degrees.

Tilt is calculated by taking the meta-data value, dividing by 8192 and then multiplying by 25. Therefore, the Tilt meta-data value of −773.7 represents an angle of −2.4 degrees.

A Focus meta-data value of 79893 corresponds to a distance of 1553 mm from the charge-coupled device (CCD).

A T-Stop meta-data value of −3009 corresponds to a T-Stop of 2.819.

A Zoom meta-data value of 84245 corresponds to a field of view of the lens (FOV) of 13.025 degrees.

A Zoom meta-data value of 84245 also corresponds to a nodal point calibration of 282.87 mm. This is the distance from CCD to the nodal point. The nodal point is also called the entrance pupil. It is where all incoming rays converge in the lens and it is where the true camera position lies. The nodal point is not fixed in space relative to the rest of the camera, but changes as the zoom of the lens changes. Again, the focus distance is from the CCD to the object in the focal plane, whereas in this particular computer simulation of the lens, the focus distance is from the point in space that represents the camera. To calculate the focal distance as used in the computer simulation, the nodal point distance must be subtracted from the real camera's focus distance. In this case, the focal distance to be used in the computer simulation would be 1553 mm−282.87 mm=1270.13 mm.

An advantage of generating the 3D computer graphics in real time is that animations can be stored in the system as well as a virtual set. By triggering the playback of an animation manually or at a specific time-code the animation can be generated so that it is produced in synchronization with the camera video, thus allowing complex special effects shots to be previewed during production. Later, in the post production phase, the animations will be rendered at a high quality, using the camera data recorded during production to ensure an accurate visual match between the recorded video and the rendered animation in terms of position, orientation, perspective, field of view, focus, and depth of field.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A system for producing composite images of real images and computer-generated three-dimensional images comprising:
a real camera configured to generate a series of real images and equipped with one or more sensors to record real camera metadata, at least one of said sensors being adapted to compute positional and orientational coordinates relative to a fixed point;
a metadata alignment device adapted to align said real camera metadata in time, said aligned camera metadata being associated with one image frame via a camera time code to form aligned associated camera metadata;
a computer system adapted to generate a two-dimensional representation of a pre-prepared three-dimensional scene using a virtual camera and further being adapted to receive said aligned associated camera metadata and to calibrate said aligned associated camera metadata against reference tables matching said real camera, said virtual camera being configured and parameterized with virtual camera parameters to simulate said real camera, said virtual camera parameters being controlled in real time, said computer system further being adapted to record calibrated camera metadata and to generate said two-dimensional representation of said pre-prepared three-dimensional scene using virtual camera metadata linked via calibrated camera metadata to the real camera, producing a series of generated images having at least one image quality corresponding with the image quality of the real images.

2. The system of claim 1 wherein said real camera metadata is selected from the group comprising focus information, t-stop information, zoom information, positional coordinates, and orientation coordinates.

3. The system of claim 1 wherein the fixed point is not connected to the real camera.

4. The system of claim 1 wherein calibrating said aligned associated camera metadata comprises calibration for the variation of lens element position of lenses of said real camera varying with zoom and focus.

5. The system of claim 1 wherein said virtual camera parameters are controlled in real time via said aligned associated camera metadata and said reference tables.

6. The system of claim 1 wherein said at least one optical quantity is selected from the group comprising position, rotation, focus, and depth of field.

7. The system of claim 1 wherein said computer system is adapted to generate said two-dimensional representation of said three-dimensional scene in response to a key press to time a display of said two-dimensional representation with said real images.

8. The system of claim 6 wherein said computer system is adapted to generate said two-dimensional representation of said three-dimensional scene in response to a key press to time a display of said two-dimensional representation with said real images.

9. The system of claim 1 wherein said computer system is adapted to generate said two-dimensional representation of said three-dimensional scene in response to a predefined time code.

10. The system of claim 6 wherein said computer system is adapted to generate said two-dimensional representation of said three-dimensional scene in response to a predefined time code.

11. The system of claim 1 wherein said reference tables contain calibration information for lens distortion, said computer system being additionally configured to distort, via calibrated camera metadata, a generated series of images to at least approximately match with the lens-based distortion of the real images.

12. The system of claim 1 wherein said computer system comprises at least two computers.

13. The system of claim 1 wherein said reference tables comprise user-selectable presets for lenses and filters.
